(19) United States
(12) Patent Application Publication
(10) Pub. No.: US 2009/0008379 A1
(43) Pub. Date: Jan. 8, 2009

(54) Infrared oven

(75) Inventor: Mats O. Ingemanson, New York, NY (US)

Correspondence Address: JOHN A. PARRISH;Law Offices of John A. Parrish, Suite 300, Two Bala Plaza, Bala Cynwyd, PA, 19004, US

(73) Assignee: Redi-Kwick Corp., New York, NY (US)

(21) Appl. No.: 12/153,360

(22) Filed: May 16, 2008

Related U.S. Application Data
(60) Provisional application No. 60/930,771, filed on May 18, 2007.

(51) Int. Cl. F27D 11/00

(52) U.S. Cl. 219/395

(57) ABSTRACT

The disclosed invention relates to an oven for cooking foodstuffs such as pizza by infrared radiation. The oven includes heating elements formed of Fe—Cr—Al alloy wire in a sealed quartz tube heating elements. The heating elements may receive power continuously or in pulses to generate infrared radiation over selected time periods to cook a foodstuff.

This application claims priority to provisional application U.S. Ser. No. 60/930,771 filed May 8, 2007.

### FIELD OF THE INVENTION

The invention relates to the field of radiant energy ovens. More particularly, the invention relates to radiant energy ovens which employ heating elements for generation of infrared radiation.

### BACKGROUND OF THE INVENTION

Most pizza restaurants use deck pizza ovens which must remain on 24 hours per day, 7 days per week. Some restaurants use convection conveyer belt pizza ovens which remain on only during the hours of operation of the restaurant. Convection conveyer belt pizza ovens, however, are more expensive to purchase than conduction deck ovens and consume more energy per hour of operation than conduction deck ovens.

Microwave ovens also have been employed to cook pizza. Microwave ovens, however, cannot be used to cook high quality pizza. Microwave ovens are employed to cook commercially available frozen pizzas. The resultant microwave cooked pizza is usually unsatisfactory.

Higher quality pizza can be baked in a conduction/convection oven. In this instance, the pizza is placed directly on the hot floor of the oven to crisp the bottom of the crust. Conduction/convection ovens, however, have “hot” spots and require constant operator attention to avoid over or under cooking of the pizza. Consistency therefore is a major problem. Moreover, conduction/convection ovens can require up to 20 minutes to cook a pizza.

In cooking and serving of pizza, energy and equipment costs have risen and have become an increasing economic burden on restaurants. In addition, productivity requirements for ovens continue to increase since restaurants desire to bake and serve pizza in the shortest possible time. In addition, restaurants have become increasingly concerned about cleanliness.

A need therefore exists for an oven which overcomes the time and energy disadvantages of the prior art ovens. A further need exists for ovens which have improved levels of cleanliness.

### DESCRIPTION OF THE DRAWINGS

FIG. 1 is a front view of an oven according to an embodiment of the present invention.

FIG. 1A is a cross sectional view taken along section AA of FIG. 1.

FIG. 1A is a cross sectional view of an alternative embodiment taken along section AA of FIG. 1.

FIG. 2 is a cross sectional view of support bracket.

FIG. 3 is an isometric view of a framework assembly having heating elements therein.

FIG. 4 is a rear view of an oven according to the present invention.

FIG. 5 is a front view of another embodiment of the oven of the invention.

FIG. 5A is a cross section of the oven of FIG. 5 taken on line A-A.

FIG. 6 is an isometric view of a box frame used in construction on an embodiment of the oven of the invention.

FIG. 6A is a cross section view of a frame member for use in construction of the oven.

FIGS. 7 and 7A are top and side views of an upper suffrage which includes electrical heating elements and a reflector.

FIGS. 8 and 8A are top and end views, respectively, of a lower suffrage which includes electrical heating elements.

FIG. 9 is an isometric view of a crumb tray with an integral reflector.

FIGS. 10 and 10A are front and side views, respectively, of an outer shell used in construction on an embodiment of the oven of the invention.

FIG. 11 is a schematic of the operation of timer, controller and heating elements.

FIG. 12 is a top view of an oven door mechanism for removal of a pizza tray from the oven of FIG. 1.

FIG. 13 is a side view of the oven door of FIG. 12.

FIG. 14 a perspective view of oven door of FIG. 12 showing the pizza rack in an extended position beyond the opening of the oven;

FIG. 15 is a top perspective view of the inner baking chamber of the oven of FIG. 1. that shows the ends of the heating elements extending beyond the boundaries of the inner baking chamber of the oven;

FIG. 16 is top perspective view of the hinge for joining of the oven door to the oven;

FIG. 17 is side view of the oven door in an open position showing the pizza tray extended beyond the inner baking chamber of the oven.

FIG. 18 shows an inner baking chamber that includes slots therein.

FIG. 19 is a front perspective view of an alternative embodiment of the oven that shows deflection wings for conducting air flow

FIG. 20 is a side perspective view of an alternative embodiment of the oven with front outer wall attached to the oven showing the lower peripheral cooling channel

FIG. 21 is a side perspective view of an alternative embodiment of the oven with rear outer wall attached to the oven showing the lower peripheral cooling channel.

### SUMMARY OF THE INVENTION

The disclosed invention relates to an oven for cooking foodstuffs such as pizza by infrared radiation. The oven includes one or more heating elements, preferably ten to twelve heating elements, formed of Fe—Cr—Al alloys, preferably a Fe—Cr—Al alloy that has abut 22% Cr, 73.2% Fe and about 4.8% Al, all amounts based on the total weight of the alloy. The heating elements preferably are in the form of a 23 gage wire. The heating elements may be housed in quartz tubes. The heating elements are available as Kanthal D alloy 815 from Kanthal Bethel, Bethel Conn. Energizing of the heating elements may be by a pulse type controller or a timer to cause the heating elements to generate infrared radiation over selected time periods to efficiently cook a foodstuff.

The oven of the invention may enable pizza and other food products to be cooked consistently to a desired state regardless of the initial temperature of the oven or fluctuations in line voltage. The oven may achieve a reduced baking time of up to about 70% to about 83% compared to the time periods of about 5 mins. to about 9 mins compared to other infra-red type ovens of the prior art.

The oven includes an inner baking chamber in spaced relationship to an outer body shell, a rotatable oven door joined to the outer body shell to permit access to the inner baking chamber, an upper array of two to twelve heating elements comprising Fe—Cr—Al alloy wire in a sealed quartz tube located in the inner chamber to generate infrared energy of a wavelength of about 2.3 micron to about 9.82 micron when energized by an electrical voltage of about VAC to about 240 VAC, and a lower array of two to twelve heating elements located in the inner chamber to generate infrared energy of a wavelength of about 2.3 micron to about 9.82 micron when energized by an electrical voltage of about 110 VAC to about 240 VAC. The heating elements have a power rating of about 200 watts to about 1000 watts, such as about 450 watts to about 500 watts, and can generate infrared radiation at intensity of about 7 KW/m² to about 100 KW/m² such as about 15 KW/m² to about 45 KW/m². The heating elements, in one aspect, receive power via a pulse type controller to vary the voltage and duration of electrical pulses to the heating elements. The heating elements, in another aspect, receive power via a timer to provide continuous, non-intermittent flow of electrical energy to the heating elements. The heating elements may generate infrared energy of a wavelength of about 2.3 micron to about 9.82 micron, preferably about 2.3 micron to about 6.5 micron, more preferably about 2.3 micron to about 5.5 micron, even more preferably about 2.3 micron to about 3.0 micron. The heating includes may include a concave reflector there over and the inner baking chamber may include a wall that has slots therein. The oven may further include a support rod assembly for supporting a foodstuff thereon where the oven door is operatively connected to the support rod assembly to enable a portion of the support rod assembly to move outwardly beyond the inner baking chamber when the oven door is rotated. The oven also may include an infrared temperature sensor positioned above the support rod assembly and an infrared temperature sensor placed below the support rod assembly whereby the sensor generates a signal to cause deactivation of one or more of the heating elements.

In another aspect, the oven may be operated to achieve self cleaning and self sanitizing.

### DETAILED DESCRIPTION OF THE INVENTION

The present invention provides an oven adapted for cooking foodstuffs such as pizza. The oven employs heating elements which generate infrared energy of a selected range of wavelengths of about 2.3 micron to about 9.82 micron, preferably about 2.3 micron to about 6.5 micron, more preferably about 2.3 micron to about 5.5 micron, even more preferably about 2.3 micron to about 3.0 micron to cook foodstuffs such as pizza as well as to kill pathogens such as E. coli, Salmonella and Bacillus Stearthermophilus.

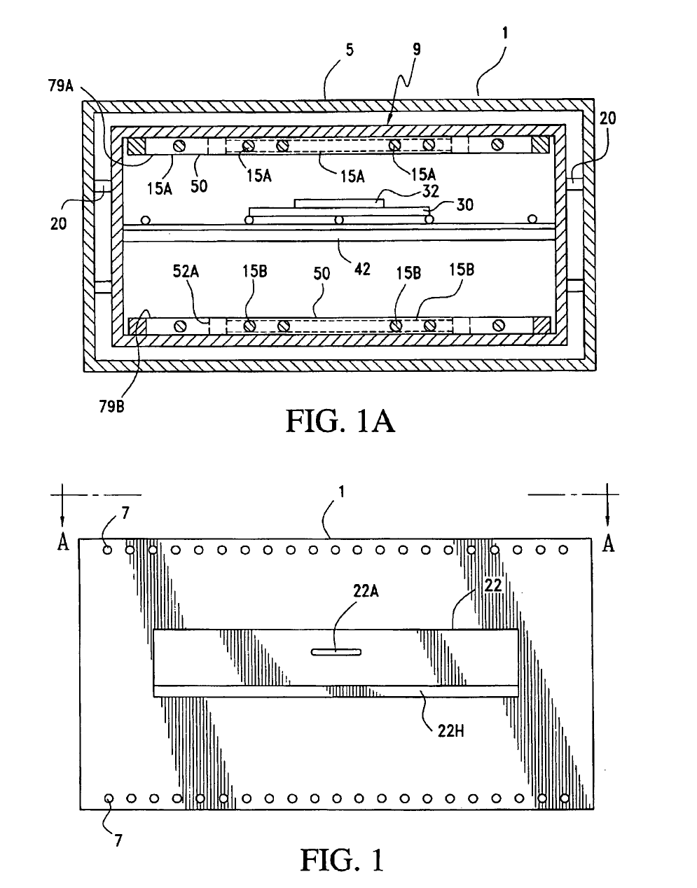

In a first embodiment, oven 1, as shown in FIGS. 1-4, includes inner chamber 9 positioned within outer body shell 5. Inner baking chamber 9 may be maintained in spaced relationship to outer body shell 5 by supports 20. Outer body shell 5 includes rotatable door 22 to permit access to inner baking chamber 9. Door 22 may be solid or have a glass section to enable viewing of a foodstuff such as pizza 32 in inner baking chamber 9 while it is being treated with radiation generated by heating elements 15A, 15B. Outer body shell 5 has openings 7 on the front and rear surfaces thereof to permit ambient air to flow into inner baking chamber 9 as well as to permit hot air to flow from baking chamber 9 to leave oven 1. Baking chamber 9, as well as interior surface of door 22 may be formed of a reflective material such as aluminum or stainless steel, preferably aluminum.

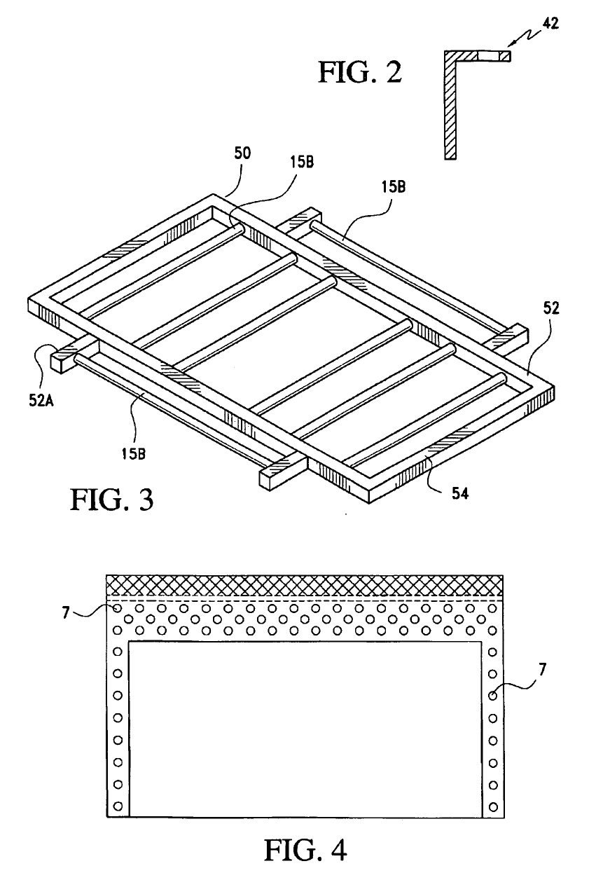

Inner baking chamber 9 may include elongated support brackets 42 for receiving a plurality of support rods 11 thereon. Support brackets 42 may have an “L” shaped configuration as shown in FIG. 2. Support rods 11 may be placed on support brackets 42 at a desired position within inner baking chamber 9 to support platter 30 that receives pizza 32 thereon. Platter 30 may be a standard wire mesh grid tray such as Pizza Screen from American Metal Craft. The rear wall of inner baking chamber 9 may have openings located along the bottom portion thereof to enable ambient air to flow into inner baking chamber 9.

Support rods 11 may be positioned at a desired distance between heating elements 15A, 15B within inner baking chamber 9 to enable pizza 32 on platter 30 to be exposed to a desired intensity of infrared radiation. Typically, support rods 11 are located about 3-7 inches, preferably about 5 inches, from upper heating elements 15A and about 3-7 inches, preferably about 5 inches, from lower heating elements 15B.

Upper and lower heating elements 15A,15B, as shown in FIG. 3, may be placed into an array and be maintained in a desired relationship to each other by framework 50. Framework 50 may be constructed from metals such as aluminum. Framework 50 includes elongated members 52 and end members 54. Elongated members 52 include lateral extending sections 52A. For purposes of illustration, and without limitation, FIG. 3 shows a framework 50 which includes heating elements 15B. It is to be understood, however, that framework 50 may be employed with heating elements 15A. Framework 50 having heating elements 15A, 15B, may be secured to the interior of baking chamber 9 by conventional fasteners such as screws (not shown).

Heating elements 15A, 15B may be formed of Fe—Cr—Al alloys, preferably a Fe—Cr—Al alloy that has 22 wt. % Cr, 73.2 wt. % Fe and 4.8 wt. % Al, all amounts based on the total weight of the alloy. The heating element preferably is in the form of about 23 gage wire to about 26 gage wire. The heating element may be housed in a quartz tube. The heating element is available as Kanthal D Alloy 815 from Kanthal Bethel, Bethel, Conn., or similar material from other manufacturers. The heating elements which may be employed have a typical power rating of about 250 watts to about 1000 watts, and may generate infrared radiation at an intensity of about 7 KW/m² to about 100 KW/m², preferably about 1.5 KW/m² to about 45 KW/m² over a wavelength range of about 2.30 microns to about 9.82 microns, preferably about 2.3 microns to about 6.5 microns, more preferably about 2.3 microns to about 3.5 microns, especially preferably about 2.3 microns to about 3.0 microns. Heating elements 15A, 15B receive power through leads connected to temperature controller 88. Temperature controller 88 may be a pulse type controller that is capable of varying the voltage and duration of electrical pulses to the heating elements.

In a first aspect of oven 1, as shown in FIG. 1A, an upper array 79A of heating elements 15A and a lower array 79B of heating elements 15B are employed. The number of heating elements may vary in each of the upper and lower arrays. Typically, an array includes two to twelve, preferably ten to twelve, heating elements.

Heating elements 15A, 15B in each array may be placed in a symmetrical or asymmetrical, preferably a symmetrical arrangement with respect to the axis of symmetry of that array. The lateral spacing between adjacent heating elements 15A, 15B as well as the vertical distance between elements 15A, 15B and a foodstuff such as pizza 32, may be varied to evenly distribute infrared energy to cook uniformly and quickly foodstuffs such as pizza 32. The rapid rate of temperature rise of heating elements 15A, 15B may reduce baking time up to about 70% to about 83% compared to infra-red type ovens of the prior art.

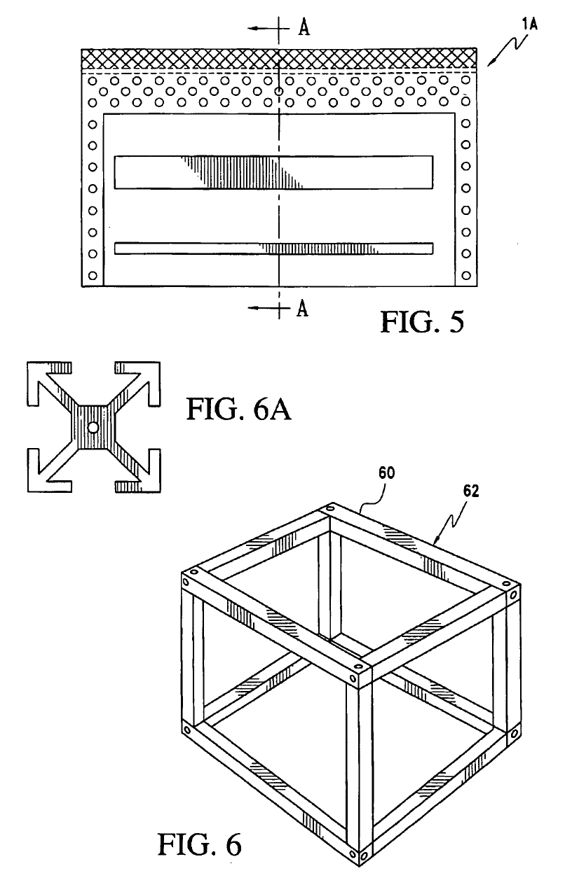

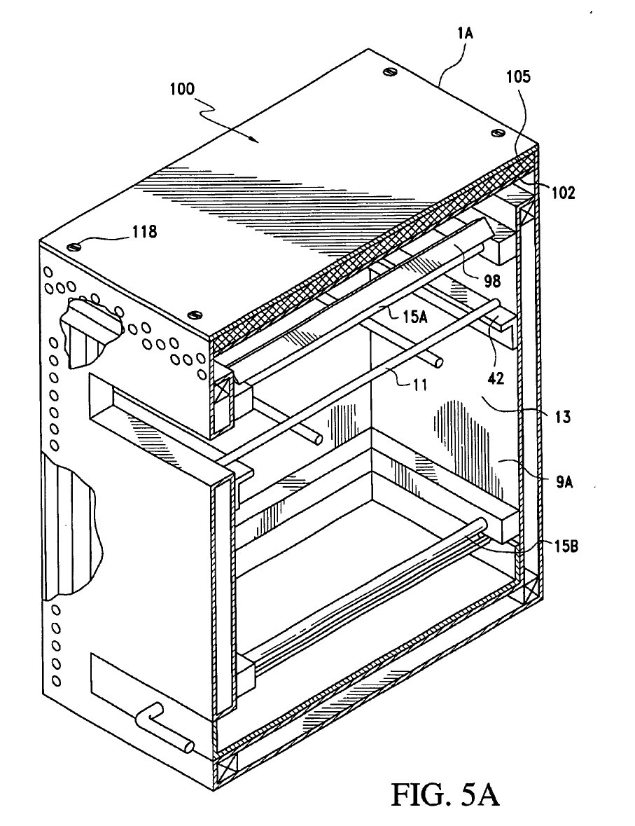

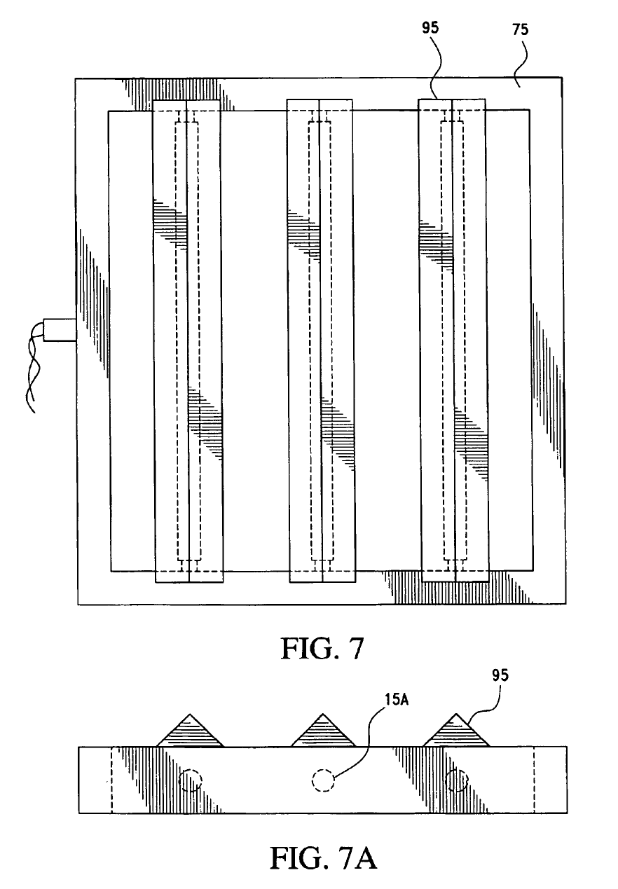

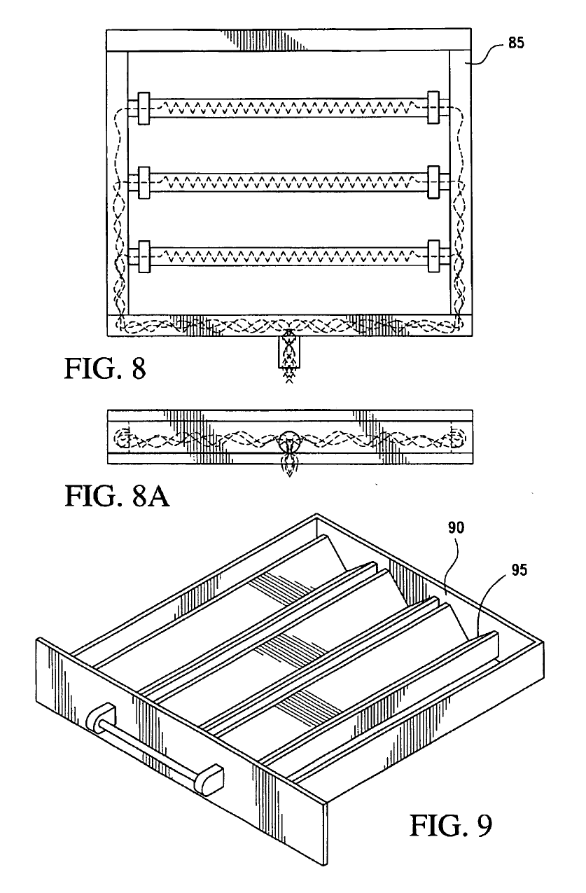

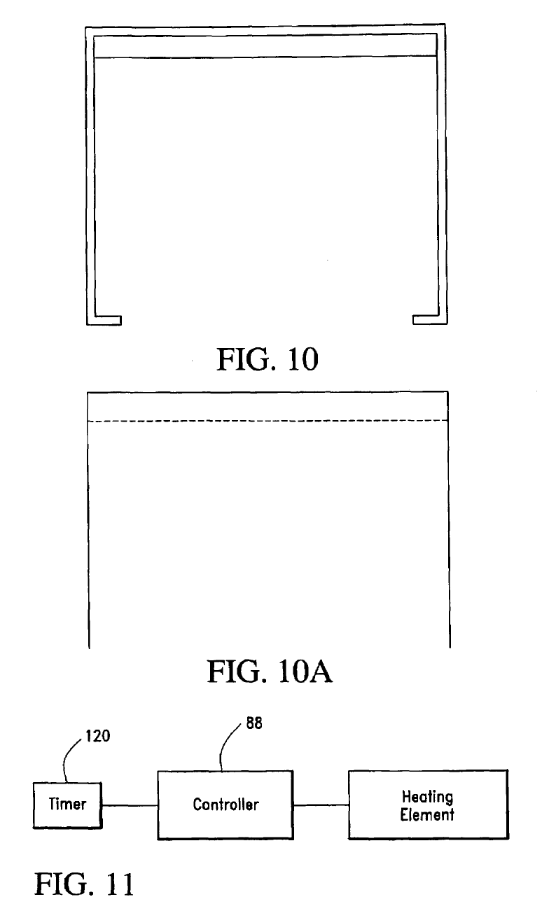

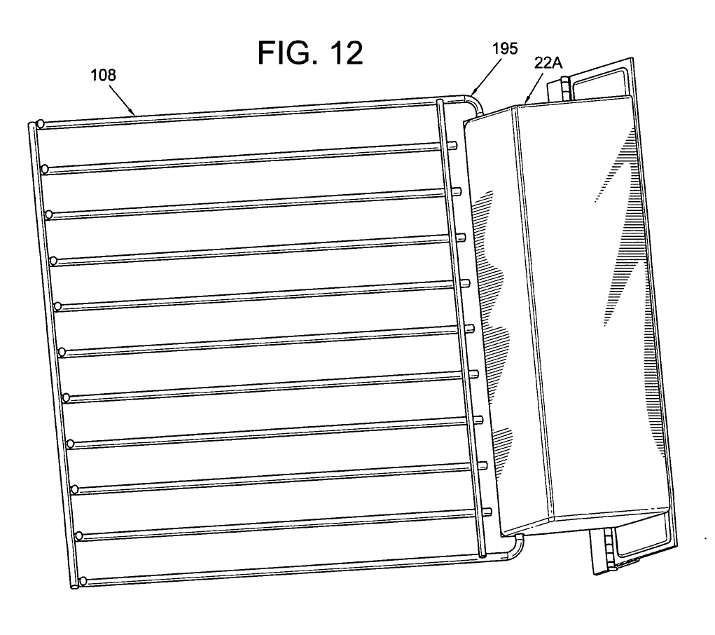

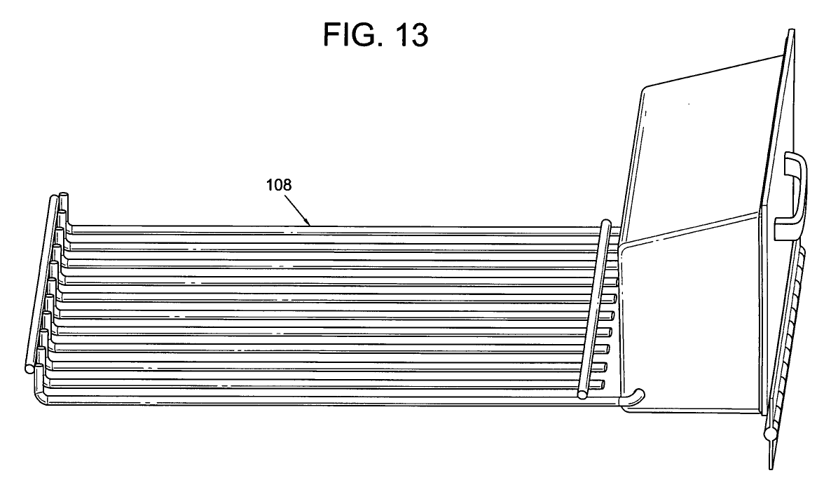

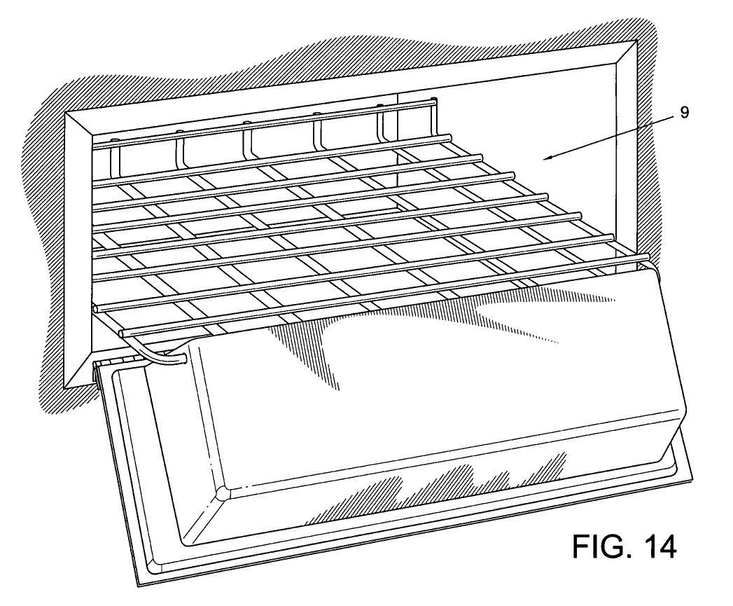

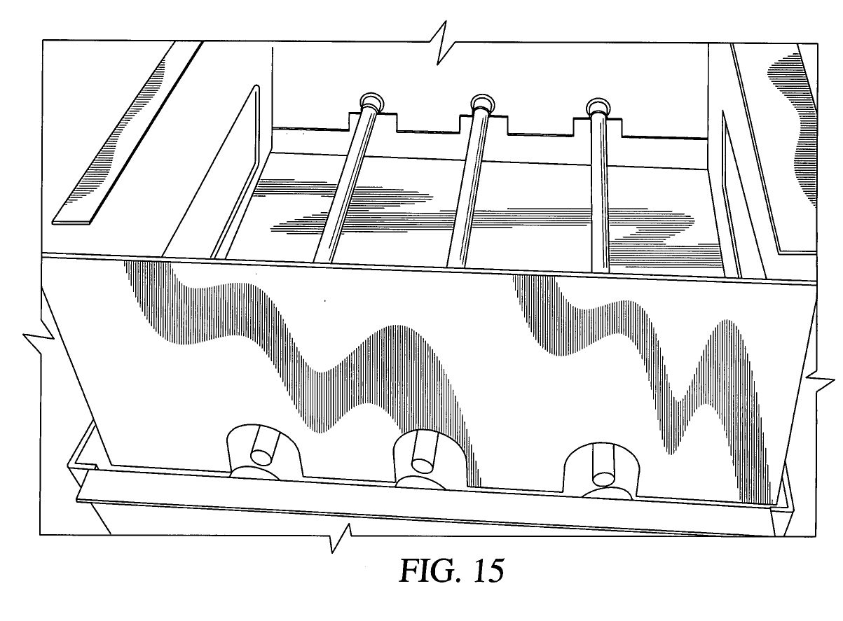

In a second embodiment, oven 1A, as shown in FIGS. 5-10, includes hollow frame members 60 assembled to form box frame 62 as shown in FIG. 6. Frame members 60 preferably have a cross section as shown in FIG. 6A. Highly reflective metal sheets such as aluminum are attached to box frame 62 to form a baking chamber that has rear, bottom and side walls. Heating elements 15A together with concave reflectors 95 are assembled onto upper subframe 75 as shown in FIGS. 7 and 7A. Upper subframe 75 is assembled from frame members 60 such as those used to form box frame 62. Heating elements 15A are secured to upper subframe 75, and optional concave reflectors 95 may be secured to upper subframe 75 over heating elements 15A Electrical leads are passed through frame members 60 of upper subframe 75 for attachment to heating elements 15A. Concave reflectors 95 may extend along a desired length of a heating element such as the entire length of the heating element. Lower subframe 85 as shown in FIGS. 8 and 8A is made similarly to upper subframe 75 except that no reflectors are attached to lower subframe 85.

The upper and lower subframes 75, 85 having the heating elements therein are attached to the side walls of baking chamber 9 by fasteners (not shown). Useful fasteners include screws, pins and the like.

Crumb tray go that may include concave reflectors 95 which have a concave curvature as shown in FIG. 9 is positioned below lower subframe 85 so that tray go and reflectors 95 are below heating elements 15B. Crumb tray go may slide into an opening provided below the bottom surface of lower subframe 85 as shown in FIG. 5. An outer shell 100 of reflective metal as shown in FIG. 5A then is attached over box frame 62 by fasteners 118. Useful fasteners include screws, pins and the like. A layer of insulation 105 such as fiberglass may be secured to the interior surface of outer shell 100 on insulation shelf 102 of outer shell 100 as shown in FIG. 5A.

In another aspect, inner baking chamber 9A includes elongated support brackets 42 for receiving a plurality of support rods 11 thereon. Interior walls such as wall 13 of inner baking chamber 9A optionally may be perforated to facilitate air flow into baking chamber 9A. Support brackets 42 may have an “L” shaped configuration as shown in FIG. 2. Support rods 11 may be placed on support brackets 42 at a desired position within baking chamber 9A. Support rods 11 function to support platter 30 that has a foodstuff such as a pizza thereon. Support rods 11 may be positioned at a desired distance between heating elements 15A, 15B within baking chamber 9A to enable a foodstuff such as a pizza to be exposed to a desired intensity of infrared radiation.

Typically, support rods 11 are positioned to enable a food stuff such as a pizza to be located about 3 inches to about 7 inches from heating elements 15A and about 3-7 inches from lower heating elements 15B depending on the number of heating elements 15A,15B employed. Where the number of heating elements 15A, 15B each number six, support rods 11 may positioned to enable a foodstuff such as a pizza to be located about 2 to 4 inches from heating elements 15A and about 2 to 4 inches from the lower heating elements 15B.

Temperature-process controller 88 enables regulation of the temperature of the heating elements and the consequent wavelength and intensity of infrared radiation received by a foodstuff such as a pizza. Controller 88 may enable upper heating elements 15A to operate at the same or different temperature from lower heating elements 15B. Controller 88 may manually be set to a pulse mode setting to control the electrical power to the heating elements. Useful temperature-process controllers 88 include Model CN 4321TR-D1 From Omega Corp., as well as Infinite Control Mechanism models CH-152 or CH-252 from Omega Engineering Corp., Stamford, Conn.

Temperature-process controller 88 is activated for a desired cooking cycle by a digital or analog timer 120 that is electrically connected to temperature-process controller 88. Useful timers include Handset Interval Timer INM from Precision Timer Co, Inc., Westbrook, Conn. and PTC-21 Series 1/16 DIN Multi-Programmable Dual Display Timers from OMEGA Engineering Corp, Stamford, Conn. When the cooking cycle is complete, timer 120 shuts off to deactivate temperature-process controller 88.

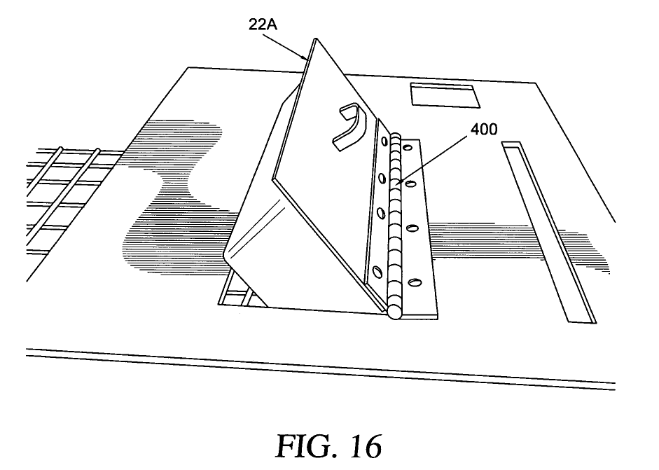

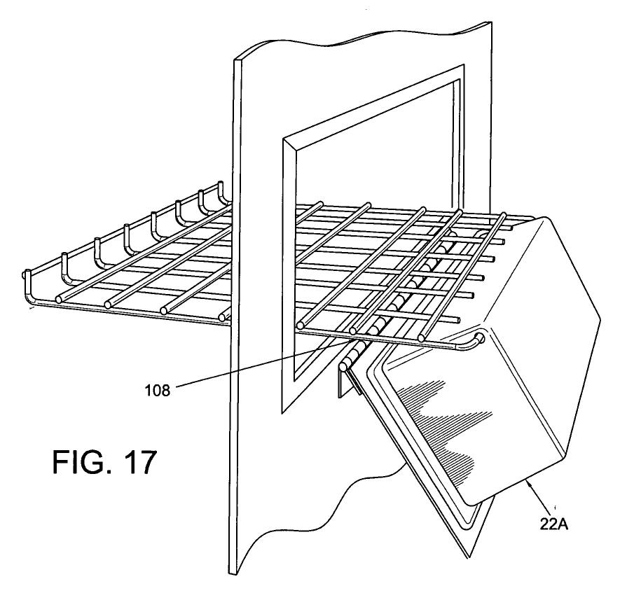

In another aspect, oven door 22A is joined to the front surface of oven 1 by an elongated hinge 400, such as a piano hinge such as that shown in FIG. 16 to enable oven door 22A to open downwardly relative to the top surface of oven 1. Oven door 22A also is hinged to support rod assembly 108 as shown in FIG. 17 where support rod assembly 108 provides support for a platter 30 having a food stuff such as a pizza thereon. Support rod assembly 108 is connected to oven door 22A whereby a portion of support rod assembly 108 is moved outwardly from baking chamber 9 of oven 1 to facilitate removal of a platter such as platter 30 from baking chamber 9 when oven door 22A is rotated relative to the front of oven 1. Oven door 22A may have an extended depth to extend within inner baking chamber 9 when closed against the front surface of oven 1. Oven door 22A may be hollow and provided with insulation such as fiberglass insulation or mineral wool. Oven door 22A may rotate over a range of about 150 degrees to about 180 degrees relative to the front surface of oven 1.

In another aspect, inner baking chamber 9 of reduced size may be used to enable shorter baking times and lower energy consumption. Reduction in volume of inner baking chamber 9 may be achieved by mounting heating elements 15A, 15B within inner baking chamber 9 as shown in FIG. 15. As shown in FIG. 15, electrical connections to heating elements such as heating elements 15B are outside of chamber 9 to place only the heated portions of heating elements 15A, 15B inside inner baking chamber 9. Inner baking chamber 9 may have a variety of configurations such as rectangular and circular.

In yet another aspect, an infrared temperature sensor such as the OS136 Series Miniature Low-Cost Non-Contact Infrared Temperature Sensor/Transmitter from OMEGA Engineering is placed above support rod assembly 108, such as about 3 inches to about 6 inches above the support rod assembly 108, and an infrared temperature sensor such as the OS136 Series Miniature Low-Cost Non-Contact Infrared Temperature Sensor/Transmitter from OMEGA Engineering is placed below support rod assembly 108, such as about 3 inches to about 6 inches below support rod assembly 108. When the surface of a foodstuff such as a pizza on support rod assembly 108, as measured by the infrared temperature sensor, reaches a desired temperature, the sensor sends a signal to a temperature-process controller such as Infinite Control Mechanism models CH-152 or CH-252 from OMEGA Engineering to deactivate one or more heating elements 15A, 15B. Both upper and lower heating elements 15A, 15B may be controlled independently to generate a desired intensity and duration of radiant energy onto a foodstuff such as a pizza on pizza tray 108. Accordingly, when the temperature of the upper surface of the pizza reaches a desired temperature, the upper set of heating elements 15A may be turned off. Similarly, when the temperature of the lower surface of the pizza reaches a desired temperature, the lower set of heating elements 15B may be turned off.

In a further aspect a protective screen mesh may be placed above, typically about 0.25 inch to about 1.0 inch above, the upper surface of oven 1 to protect against accidental touching of the hot surfaces of oven 1. The screen mesh may have a mesh size of about 0.15 inch square to about 0.25 inch square. Useful screen mesh may be obtained from Gerard Daniel Worldwide Corporation in Hanover, Pa. The screen mesh may be made from plastic, steel, aluminum, brass or any other suitable metals.

In yet another aspect, insulation 105 may be placed adjacent one or more internal walls of oven 1 as shown in FIG. 5A. Useful insulation materials include but are not limited to materials such as Calcium Silicate Board from McMaster-Carr. Particularly useful Calcium Silicate Board has a Heat Flow Rate of 0.7 Btu/hr.×in./sq. ft. @ 800° F. and a density of 14.5 lbs./cu. ft. Other useful insulation materials include Electrical Grade Fiberglass sheets from McMaster-Carr such as those which have a thickness of about 0.25 inches or more. Electrical Grade Fiberglass typically has a tensile strength of about 10,000 PSI and a rating of UL 94Vo according to the specifications of the Underwriters Laboratories (UL). Yet other useful insulation materials include Oak Wood of about 0.25 inches thick or more. An air space may be provided between the walls of oven 1 and the wood insulation. An air space may be provided between one or more walls of the oven and the insulation.

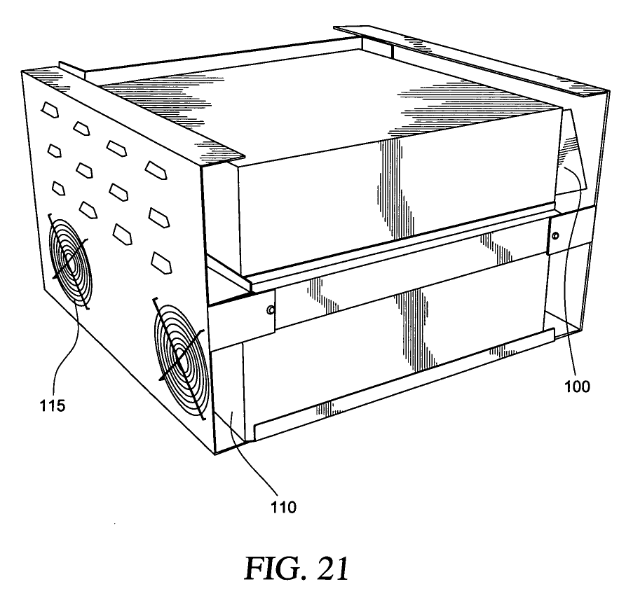

In still yet another alternative embodiment of the invention, the oven includes a forced air cooling system. The cooling system advantageously cools the front surfaces of the oven and may also be used to cool the bottom surface of the oven. In this aspect, and as shown in FIG. 1A, as well as 19-21, the front surfaces of the oven includes deflection wings 100. Access to the baking chamber of the oven includes access extensions 105. Outer shell 5 may be configured to provide cooling channels 110 between bracket 20 and the walls of outer shell 5. Cooling channels 110 may extend around the entire lower periphery of the oven as well as directly beneath the oven. An additional cooling channel 110 is provided over the surface of the upper wall of the oven and the inner surface of outer wall 5. One or more fans 115 are provided in the lower portion of the rear wall of outer shell 5 as shown in FIG. 21.

In use, fans 115, operating at about 35 CFM to about 110 CFM draw ambient air into lower cooling channel showing the lower peripheral cooling channel that extends around the lower periphery of the oven and also may flow in the channel formed between the bottom of the oven and outer shell showing the lower peripheral cooling channel. Air flows through the channels toward the front of the oven where it is deflected upwardly by the front wall of shell showing the lower peripheral cooling channel. The air flow is deflected by wings showing the lower peripheral cooling channel toward the upper surface of the oven between a channel formed between the upper surface of the oven and shell showing the lower peripheral cooling channel and flows toward the rear of the oven. The air exits the oven though vents showing the lower peripheral cooling channel.

### Operation

During operation of oven 1 to cook a foodstuff such as pizza 32, platter 30 having pizza 32 thereon is first placed on support rods 11 at a desired distance from each of heating elements 15A,15B within inner baking chamber 9. Platter 30 may be a standard grid tray such as Pizza Screen from American Metal Craft. Heating elements 15A, 15B are placed both above and below pizza 32 to expose pizza 32 to the infrared radiation generated by the heating elements. Upper heating elements 15A may be operated at the same or different power levels from lower heating elements 15B.

A sensor and a temperature-process controller are used to control electrical energy supplied to the heating elements. A useful sensor is Model no. TJ 36-CASS-14U-12 from Omega Corp., Stamford, Conn. The sensor is placed in contact with the quartz tube component of the heating element. The sensor senses the temperature of the tube and forwards it to the temperature-process controller. A useful temperature-process controller is a maintenance pulse type temperature-process controller such as Model CN 4321 TR-D1 from Omega Corp. The temperature-process controller is preset to a desired temperature value to control the electrical energy sent to the heating elements. The temperature-process controller may enable the upper and lower heating elements to receive differing amounts of electrical energy. Preferably, however, the temperature-process controller enables each of the upper and lower heating elements to receive about equal amounts of electrical energy so that all of the heating elements may operate at about the same temperature.

During operation, when the temperature of the heating elements is about equal to the preset temperature value of the controller, the controller may adjust the electrical energy supplied to the heating elements to control the temperature of the heating elements and the consequent wavelength and intensity of the infrared radiation received by a foodstuff such as pizza 32.

A Kanthal D Alloy 815 heating element, when energized by Model CN 4321 TR-D1 temperature-process controller, causes the heating element to operate at a temperature of about 900° C. to about 1000° C. The time to temperature behavior of the Kanthal D Alloy 815 heating element when energized by Model CN 4321 TR-D1 temperature-process controller is shown in Table 1.

TABLE 1
Time to Temperature at Controller Preset Temperature of 946 C.

| Time | Temperature C. of | Wavelength¹ |
|---|---|---|
| (Sec) | Heating Element | (microns) |
| 0 | 22 | 9.82 |
| 30 | 757 | 2.81 |
| 60 | 926 | 2.42 |
| 90 | 946 | 2.38 |
| 120 | 946 | 2.38 |
| 150 | 946 | 2.38 |

¹Wavelength of infrared radiation calculated from Wien's law

In a second embodiment of the oven, each of the upper and lower heating elements 15A, 15B is a QIM-166 heating element from Thermo Innovations Corp. that has a rating of about 300 watts to about 700 watts. Each of the heating elements optionally may have a concave reflector 95 associated therewith. The heating elements may be energized by a pulse type temperature-process controller such a Infinite Control Mechanism models CH-152 or CH-252 from Omega Corp. The controller is set to a desired value to control the flow of electrical energy to the heating elements. The controller enables upper heating elements 15A to operate at the same or different temperature from lower heating elements 15B.

The invention is further illustrated below by reference to the following non-limiting Examples.

### EXAMPLE 1

An upper array of three heating elements and a lower array of three heating elements are employed. The heating elements in each array are Kanthal D Alloy 815 heating elements housed in a quartz tube. A concave reflector is employed with each of the heating elements in both the upper and lower arrays. The temperature-process controller employed for providing electrical power to the heating elements is a CH-252 controller from Omega Engineering Corp.

The CH-252 controller has a maximum power rating of 5800 watts and operates at 110 VAC to 240 VAC. A Shoprite 12 inch pizza is located 4.5 inches from each of the upper and lower arrays of heating elements. The setting of the controller is 5 for the top array of elements and 6 for the lower array of elements. These settings cause the CH-252 controller to provide pulses of electrical energy at 240 V to each upper and lower heating elements. The duration of the pulses is 6 sec and the time period between pulses is 8 sec for the upper array of heating elements. The duration of the pulses is 8 sec and the time period between pulses is 7 sec for the lower array of heating elements.

In another aspect, after or during the cooking of a foodstuff, the oven may be operated to achieve self sterilization. To confirm sterilization, a CS-100 model no. bacterial sterilization monitor strip form SPS Medical Corp. is employed. The strip has Bacillus Stearthermophilus or Bacillus Subtilis thereon. The oven achieves sterilization in 45 sec as shown in Table 2 when employing a Kanthal D 23 gage wire element housed in a quartz tube.

TABLE 2
Time to Temperature

| Time | Temperature C. of | Wavelength¹ | Bacillus |
|---|---|---|---|
| (sec) | Heating Element | (microns) | Stearthermophilus |
| 0 | 23 | 9.79 | Survivors |
| 15 | 605 | 2.81 | Survivors |
| 30 | 757 | 2.42 | Survivors |
| 45 | 832 | 2.38 | No Survivors |
| 60 | 926 | 2.38 | No Survivors |
| 90 | 946 | 2.38 | No Survivors |
| 120 | 946 | 2.38 | No Survivors |

¹Wavelength of infrared radiation calculated from Wien's law

### EXAMPLE 2

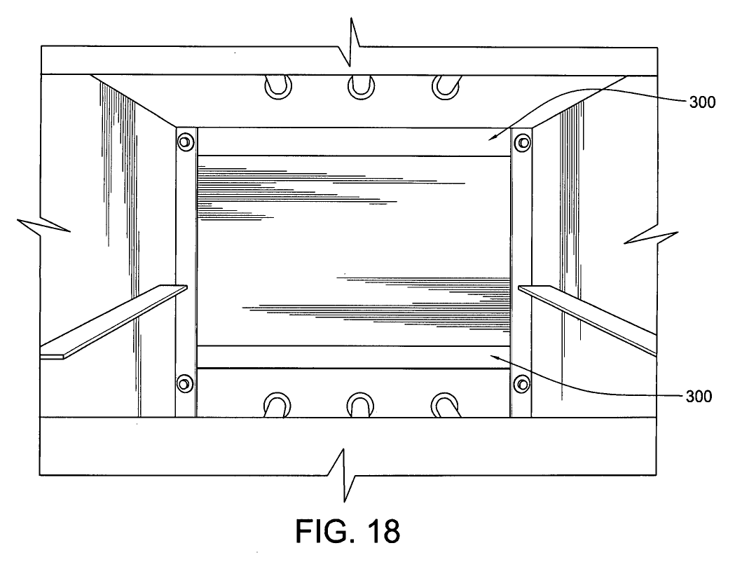

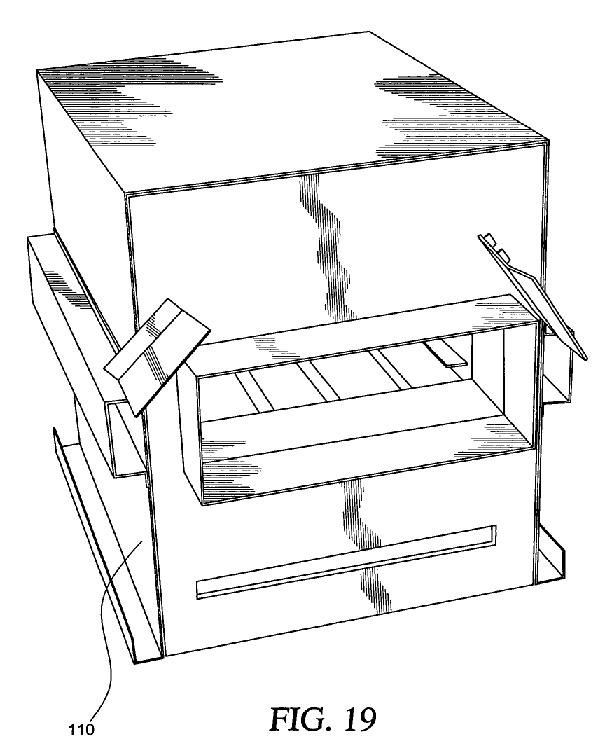

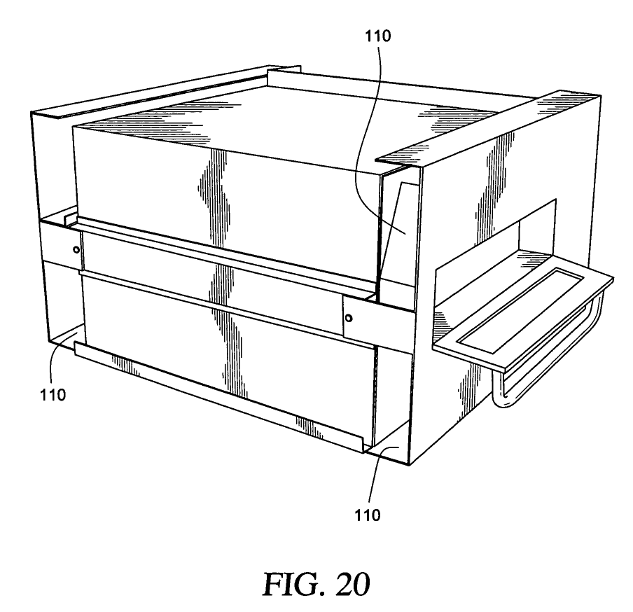

The procedure of example 1 is employed except that concave reflectors are not included and a Red Lion Controller C48TD102 is substituted for the CH-252 controller to provide continuous power to the heating elements. The size of the heating baking chamber measures 8 inches by 9 inches by 10 inches. The ends of the heating elements, as shown in FIG. 15, extend beyond the boundaries of the baking chamber. The oven includes upper and lower slots as shown in FIG. 18. The Kanthal D alloy 815 elements employed have a thickness of 23 gage, a power rating of 450-500 watts and operate at 120 VAC. A pizza having a diameter of 7.5 inches and a thickness of 0.375 inches is baked in 50 sec.

The front control panel of the oven advantageously has a low, ambient temperature during operation. This is illustrated in Table 3. The procedure used to take the temperature measurements employed a Fluke 61 Infrared Thermometer to measure the surface temperature on three locations of the front surface of the oven. Location 1 in on the surface of the control panel on the front of the oven. Location 2 is on the front surface of oven door 22A of the oven. Location 3 is on the surface of the crumb tray.

TABLE 3

| Time | | | |
|---|---|---|---|
| (minutes) | Location 1 | Location 2 | Location 3 |
| 1 | 80 F. | 92 F. | 95 F. |
| 2 | 118 | 145 | 126 |
| 3 | 142 | 203 | 160 |
| 4 | 181 | 257 | 180 |
| 5 | 214 | 308 | 220 |
| 6 | 245 | 334 | 246 |
| 7 | 276 | 380 | 273 |
| 8 | 312 | 403 | 298 |

When a ¼ inch thick layer of polyethylene is placed on front plate of the oven with screws and 0.25 inch spacers to provide a ¼-½ inch air space between the front plate of the oven and the heat shield, the temperatures in Table 4 are obtained. The procedure used to take these measurements was by using a Fluke 61 Infrared Thermometer to measure the surface temperature on three locations of the front of the oven. Location 1 is on the surface of the control panel on the front of the oven. Location 2 is on the front surface of oven door 22A of oven. Location 3 is the surface of the crumb tray.

TABLE 4

| Time | | | |
|---|---|---|---|
| (minutes) | Location 1 | Location 2 | Location 3 |
| 0 | 67 F. | 67 F. | 67 F. |
| 1 | 67 | 67 | 67 |
| 2 | 68 | 67 | 67 |
| 3 | 68 | 69 | 68 |
| 4 | 68 | 70 | 69 |
| 5 | 71 | 74 | 70 |
| 6 | 75 | 81 | 72 |
| 7 | 81 | 90 | 76 |
| 8 | 84 | 98 | 79 |

When a ⅛ inch thick layer of commercially available reflective aluminum foil house insulation material with air bubbles such as from Home Depot may be used as part of the heat shield that is placed with a ¼-½ inch air space from the front plate of the oven, the following temperatures on the surface of the polyethylene are obtained as shown in Table 5. The procedure used to take these measurements entailed use of a Fluke 61 Infrared Thermometer to measure the surface temperature on three locations of the front of the oven. Location 1 is on the surface of the control panel on the front of the oven. Location 2 is on the front surface of oven door 22A of the oven. Location 3 is on the surface of the crumb tray.

TABLE 5

| Time | | | |
|---|---|---|---|
| (minutes) | Location 1 | Location 2 | Location 3 |
| 0 | 66 F. | 66 F. | 66 F. |
| 1 | 66 | 66 | 66 |
| 2 | 67 | 66 | 66 |
| 3 | 66 | 66 | 66 |
| 4 | 67 | 67 | 66 |
| 5 | 67 | 68 | 67 |
| 6 | 69 | 70 | 68 |
| 7 | 69 | 74 | 70 |
| 8 | 72 | 79 | 72 |

In another aspect, slots 300 are provided in the rear of baking chamber 9 as shown in FIG. 18. In this aspect, slots 300 enable more uniform air flow through baking chamber 9.

1. An oven comprising, in combination, an inner baking chamber in spaced relationship to outer body shell,
a rotatable oven door joined to the outer body shell to permit access to the inner baking chamber,
an upper array of two to twelve heating elements comprising Fe—Cr—Al alloy wire in a sealed quartz tube located in the inner chamber to generate infrared energy of a wavelength of about 2.3 micron to about 9.82 micron when energized by an electrical voltage of about 110 VAC to about 240 VAC, and
a lower array of two to twelve heating elements located in the inner chamber to generate infrared energy of a wavelength of about 2.3 micron to about 9.82 micron when energized by an electrical voltage of about 110 VAC to about 240 VAC.
